(19) United States
(12) Patent Application Publication
(10) Pub. No.: US 2007/0023292 A1
(43) Pub. Date: Feb. 1, 2007

(54) SMALL OBJECT MOVING ON PRINTED CIRCUIT BOARD

(75) Inventors: Chang-Jin Kim, Beverly Hills, CA (US); Jian Gong, Los Angeles, CA (US)

Correspondence Address: Vista IP Law Group LLP, 9th Floor, 2040 Main Street, Irvine, CA, 92614, US

(73) Assignee: The Regents of the University of California, Oakland, CA (US)

(21) Appl. No.: 11/460,188

(22) Filed: Jul. 26, 2006

Related U.S. Application Data
(60) Provisional application No. 60/702,367, filed on Jul. 26, 2005.

(51) Int. Cl. B03C 5/02

(52) U.S. Cl. 204/643; 204/547

(57) ABSTRACT

A printed circuit board based digital or droplet microfluidic system and method for producing such microfluidic system are disclosed. The digital microfluidic device comprises a printed circuit board having a substrate and a plurality of electrode pads disposed on the top surface of the substrate in a rectangular array. A via extends from each electrode pad through the substrate to other locations on the substrate . A dielectric layer is disposed on the electrode pads. Droplets may be manipulated using electrowetting principles and others by applying a voltage to the desired electrodes. Each electrode pad can be controlled directly and independently from the other electrode pads to modify the surface wettability of the dielectric layer in the vicinity of the electrode pad by applying a voltage to the desired electrode pad(s). In this way, droplets may be formed, moved, mixed, and/or divided or other small objects manipulated while in air or immersed in a liquid on the dielectric surface.

### REFERENCE TO RELATED APPLICATIONS

This Application claims the benefit, under 35 U.S.C. Section 119 and any other applicable laws, of U.S. Provisional Patent Application No. 60/702,367 filed on Jul. 26, 2005. U.S. Provisional Patent Application No. 60/702,367 is incorporated by reference as if set forth fully herein.

### STATEMENT REGARDING FEDERALLY SPONSORED RESEARCH AND DEVELOPMENT

The U.S. Government may have a paid-up license in this invention and the right in limited circumstances to require the patent owner to license others on reasonable terms as provided for by the terms of Grant No. NCC2-1364 by the National Aeronautics and Space Administration.

### FIELD OF THE INVENTION

The field of the invention generally relates to systems for manipulating small objects such as fluid droplets, and more particularly, to a system which utilizes a printed circuit board having a plurality of electrodes for exerting motive effects on small objects within the system.

Background of the Invention

The term “microfluidic system” refers to devices for handling of fluids having features typically ranging in size from a few millimeters down to micrometers and smaller The term “small object” refers objects having a nominal dimension of a few millimeters or smaller. The term “digital microfluidics” or “droplet microfluidics” refers to microfluidics wherein the fluids are handled in as small packets, such as droplets, measuring from a few microliters down to picoliter and even smaller volumes.

Although much of the description in this application is directed to microfluidics, more particularly digital microfluidics, and microfluidic systems, the principles, devices and methods are equally applicable to systems which handle any small objects, and the present invention should not be limited to handling fluids. A movable object can be liquid or solid and immersed in a gas or liquid environment in various combinations of objects and environments. Examples are, liquid droplets in air, liquid droplets in another liquid, gas bubbles in liquid, gas-containing liquid bubbles in gas, fluid-containing solid bubbles in liquid, solid balls in gas, or solid particles in liquid.

Microfluidic systems have found application in various technical fields including biotechnology, chemical processing, medical diagnostics, energy, electronics, and others. Often, microfluidic systems are developed by the technologies of microelectromechanical systems (MEMS) and implemented on various substrates using the fabrication methods similar to those for integrated circuitry. Such systems have been developed for applications including, for example, analysis and detection of polynucleotides or proteins, analysis and detection of proteins, assays of cells or other biological materials, and PCR (polymerase chain reaction amplification of polynucleotides). These systems are commonly referred to as lab-on-a-chip devices.

Various systems and methods of manipulating the fluids within a microfluidic system have been devised and disclosed. Several examples of mechanical mechanisms that have been used include piezoelectric, thermal, shape memory alloy, and mechanical positive displacement micropumps. These types of pumps utilize moving parts which may present problems related to manufacturability, complexity, reliability, power consumption and high operating voltage.

Fluid handling devices without moving parts have also been utilized. Examples of such systems have used devices which manipulate fluids using electrophoresis, electroosmosis, dielectrophoresis, magnetohydrodynamics, and bubble pumping. Electrokinetic mechanisms (i.e., electrophoresis and electroosmosis) are limited because to operating liquids that contain ionic particles. Moreover, they require high voltage and high energy dissipation, and are relatively slow. Dielectrophoresis requires asymmetric electric fields and lacks the design flexibility to serve as an actuation mechanism to generate continuous flows. Likewise, magnetohydrodynamics and thermal bubble pumping require relatively high power to operate.

Handling of fluids in discrete volumes with a microfluidic system has also been reported. Often called digital microfluidics or droplet microfluidics, this approach of handling fluids, mostly as liquid droplets in air or in oil, popularly uses the principle of electrowetting has also been reported. Electrowetting refers to the principle whereby the surface wetting property of a material (referred to herein as “wettability”) can be modified between various degrees of hydrophobic and hydrophilic states by the use of an electric field applied to the surface.

As used herein, “wettability” refers to the property of a surface which causes a liquid on the surface to tend to minimize or maximize the contact area between the liquid and the surface. The terms “hydrophobic” and “hydrophilic” refer to the relative wettability of a surface, wherein “hydrophobic” refers to the property of having a tendency to repel water (and other liquids) and “hydrophilic” refers to the property of having an affinity for water (and other liquids). A modification in the wettability of a surface means that the surface is made to be more or less hydrophobic, more or less hydrophilic, changed from hydrophilic to hydrophobic, or changed from hydrophobic to hydrophilic.

The electrowetting surface for these types of applications has commonly been a hydrophobic conductive layer or a conductive layer covered with a hydrophobic dielectric film. Electrowetting on a dielectric-coated conductive layer is most popularly used because of its reversibility and has been termed electrowetting-on-dielectric or “EWOD” systems. The EWOD device operates to manipulate fluid droplet by locally changing the surface wettability of the electrowetting surface in the vicinity of the fluid by selectively applying voltage to electrodes under a dielectric film in the vicinity of the fluid. The change in surface wettability causes the shape of the droplet to change. For example, if an electrical potential is applied to an electrode adjacent to the location of the droplet, thereby causing the surface at the adjacent location to become more hydrophilic, then the droplet will tend to be pulled toward the adjacent location. As another example, if voltages are applied to electrodes on two adjacent sides of a droplet, the adjacent surfaces tend to pull the droplet apart, and under proper conditions, the droplet can be divided into two separate droplets. These electrowetting dynamics can be used to manipulate liquids in several useful ways, including creating a droplet from a liquid reservoir, moving a droplet, dividing or cutting a droplet, and mixing or merging separate droplets. With the ability to controllably perform these types of functions on liquid droplets, a useful microfluidic system is realized.

Prior microfluidic devices for handling droplets using electrowetting use substrates with a pattern of electrodes on the surface of the substrate. In the simplest such device, a two-dimensional (2-D) pattern of electrodes can be formed from a single electrode layer with electrical connections to each electrode formed from the same layer. In order to provide efficient droplet handling between adjacent electrodes, the electrodes must be placed very close together, indeed, in most cases, the closer to the better. Accordingly, the space or gap between the perimeters of adjacent electrodes is very small. This leaves very little room to run electrical connection lines to each of the electrodes on the same surface of the substrate as the electrodes. For simple microfluidic systems dedicated to specific microfluidic protocols, the system has a limited number of electrodes and the electrodes can be laid out essentially in a one-dimensional (1-D) line pattern to provide sufficient space between the electrodes for electrical lines on the single layer. In this case, fairly simple chip fabrication of a single electrode/electrical line layer can produce a variety of electrode patterns dedicated to specific microfluidic protocols. However, these types of chips do not allow for reconfigurability or user-customizable applications on single chip design.

To provide for reconfigurability and user-customization of the microfluidic processes to be performed on a chip, a two-dimensional (2-D) regular electrode array of M rows by N columns (M×N) with the ability to electrically access each point on the grid is desired. FIG. 1 shows a schematic representation of a chip 10 having M×N electrodes 12 arranged in a rectangular array and a representative conduction line 14. As shown in FIG. 1, as the number of electrodes 12 in the 2-D array increases, the number of lines from the inner electrodes to the exterior likewise increases. For a single layer system, those lines 14 must run through the electrode gap D, which must be kept minimal to avoid the loss of electrowetting efficiency. Thus, even a somewhat small 2-D grid leaves little room on the grid surface for electrical connections. Several solutions to this problem have been suggested.

To allow for 2-D operation without greatly complicating fabrication, a system 16 has been disclosed which uses a cross-referencing scheme having two chips 18 and 20 each with a single electrode layer 22 orthogonally arranged as shown in FIG. 2. The two chips 18 and 20 form a fluid passage 19 within which droplets 21 are contained. Each row of electrodes 24 on each of the chips is electrically connected such that no connecting line needs to be routed between the rows. By energizing the opposing row and column electrodes of the opposing chips with opposite signals, the cross electrode spot becomes the most wettable surface, and thus a droplet will be pulled toward it. However, this type of system presents functional limitations, such as the ability to simultaneously drive multiple droplets, which may require the development of a time-multiplexed driving scheme. In addition, since all of the electrodes on both the top and bottom chips need to be connected to a control circuit, the electrical connection and device packaging are made more complex.

In another design, the electrical connection lines are provided on different layers from the electrodes. In general, this type of device requires a multilayer arrangement of electrodes with each of the M×N electrodes to be accessed directly and independently through underlying electrode wiring. An exemplary system 26 is shown schematically in FIG. 3. As shown in FIG. 3, the top electrode layer 28 on the bottom plate 30 has a patterned array of electrodes 32 and the layer underneath has the electrode wiring 34. A top plate 35 is disposed above the bottom plate 30 separated by a space which defines a fluid passage 19 within which the droplets 21 are handled. The top plate 35 may comprise a grounding electrode 36 which functions as the opposing electrode to the electrodes 32 to apply an electric potential across the droplets 21 within the passage 19. Such designs have been proposed to be built on a substrate produced using integrated-circuit (IC) fabrication techniques. However, microfluidic devices typically have much larger chip areas than typical electronic IC chips, have much smaller production volumes compared with IC chips, and are desired to be disposable after a single use, or just a few uses. The droplet operation also requires multi-layer chips to be planarized, further increasing the chip cost. As a result, the cost for such multilayer IC substrates is too high for typical microfluidic applications.

Accordingly, there is a need for a microfluidic device which overcomes some of the drawbacks associated with prior devices.

### SUMMARY OF THE INVENTION

The present invention provides a device capable of moving small objects on its surface based on a multi-layer printed circuit board (“PCB”), and methods for producing such a device. Most typically, the device is a digital microfluidic system, as the movable objects are liquid droplets. The device of the present invention comprises a PCB having a substrate with a top surface and a bottom surface and optionally several middle interconnecting layers. A plurality of electrode pads is disposed on the top surface of the substrate . Each electrode pad is electrically isolated from adjacent electrodes by a gap or space between the electrodes. A via (a hole with a conductive material in it) extends vertically from each electrode pad through the substrate to a contact electrode at another location of the substrate, either on the bottom surface of the substrate or on the top surface away from the electrode pads, to connect the electrode pads to a control device. A driving surface is disposed on the electrode pads. The driving surface is the surface on which the small objects (such as fluid droplets) can be manipulated by exerting effects on the small objects using voltages applied to the electrode pads. The driving surface is considered to be “on” the electrode pads even though there may be intervening layers between the driving surface and the electrode pads, such as a dielectric layer, a hydrophobic layer and/or a low friction layer. Accordingly, voltage can be applied directly and independently to each electrode pad even in a large array to control the wettability of each electrode pad. The PCB may have a conventional hard substrate or a flexible substrate.

In another embodiment, a top plate is placed over the printed circuit board with spacers placed there between to form a space between the top plate and the PCB. The space forms the passage of the device having a driving surface. Depending on the configuration, the driving surface can be the surface of the electrodes, or a dielectric layer or low-friction layer if provided onto the surface of the electrodes. The electrode pads are configured to modify the surface wettability of the driving surface in response to an electrical potential being applied to one or more of the electrode pads. Selective application of an electrical potential to the desired electrode pads selectively modifies the surface wettability of the activated pads in order to manipulate droplets contained within the space. For example, droplets may be created from a reservoir, moved, divided, and/or mixed. The microfluidic device is completely reconfigurable and customizable to perform any desired series of functions on one or more droplets because each electrode pad can be independently controlled. Moreover, the independent control allows the straightforward, simultaneous manipulation of multiple droplets.

The method of producing a fluidic system according to the present invention begins with a PCB blank. The PCB blank generally comprises a substrate having a top surface and a bottom surface, and a conductive layer on the top surface of said substrate layer. The conductive layer usually begins by fully covering the top surface of the substrate layer, i.e. it is a solid surface without a pattern. Next, the conductive layer is etched to remove portions of the conductive layer to provide an array of electrodes on the top surface of the substrate layer. The etching process is well-known in the art, and typically utilizes a photo-etching process in which certain areas of the conductive layer are protected from an etching agent, while other areas are left unprotected such that the etching agent removes the conductive layer material in those areas. In this case, the etching process removes the material in between the electrodes which defines the gap between each electrode. Thus, each of the electrodes in the array has a perimeter with a substantially non-conductive gap between the perimeters of each adjacent electrode.

A via is provided for each said electrode so the each electrode can be independently actuated by an electrical voltage. Each via extends from its respective electrode through the substrate to a contact electrode at or near the bottom surface of the substrate, or using the intermediate conductive layers in the substrate, to another location away from the electrode pads on the top surface of the substrate. Each via provides an electrical connection between its respective electrode pad and the contact electrode. The vias may be provided as part of the original, unprocessed PCB blank, or before or after the etching step.

Most typically, a dielectric layer is provided onto the conductive layer comprising the electrode pads. A top plate is placed over the dielectric layer with a space between the top plate and the dielectric layer such that the space forms a passage for the liquid droplets. A surface of this passage forms the driving surface wherein the wettability of the driving surface can be modified by applying an electrical potential to one or more of the electrodes. In one aspect of the invention, the dielectric layer itself is hydrophobic and is utilized as the driving surface. In another aspect of the invention, the dielectric layer can be coated with a hydrophobic layer wherein the hydrophobic layer represents the driving surface. In yet another aspect of the invention, the hydrophobic layer is replaced with a low-friction material that is not necessarily hydrophobic.

In another embodiment of the method of the present invention, the surface topography of the PCB blank may first be improved for droplet operation prior to performing the process steps described above. The copper conductive layer of typical PCB blanks may be too thick and/or not smooth enough to provide efficient digital microfluidic functions. Thus, prior to etching the original conductive layer to produce the array of electrodes, the entire functional area of the conductive layer is removed and then replaced by a conductive layer which is thinner and/or has a smoother surface topography than the original copper layer. Or, the original conductive layer is thinned down and/or smoothened by a lapping process, such as chemical and mechanical planarization (CMP).

### BRIEF DESCRIPTION OF THE DRAWINGS

FIG. 1 is a top view of a single electrode layer digital microfluidic chip having M×N electrodes arranged in a rectangular array.

FIG. 2 is a cross-sectional side view of a digital microfluidic device having two single electrode layer chips and utilizing a cross-referencing electrode scheme.

FIG. 3 is a cross-sectional side view of a digital microfluidic device having a multi electrode layer chip with the electrode pads on one layer and the electrical connections on an underlying layer.

FIG. 4 is a cross-sectional schematic view of a digital microfluidic device in accordance with the present invention.

FIG. 5 is a partial top view of a PCB substrate of a digital microfluidic device according to the present invention which shows two complete electrode pads, the vias for each electrode and the gap between the electrodes and the adjacent electrodes.

FIG. 6 is a cross-sectional view of FIG. 5.

FIG. 7 is a chart of EWOD Operation Voltage and Electrolysis Voltage vs. Dielectric layer thickness for one example of the present invention.

FIG. 8 is a table of EWOD Operation Voltage vs. Parylene C dielectric thickness for one example of the present invention.

FIG. 9 is a schematic illustrating the processing of a PCB substrate according to the present invention.

FIG. 10 includes photographs of a top view of a digital microfluidic system according to the present invention showing the operation of the system on droplets.

FIG. 11 is a perspective exploded view of a digital microfluidic system according to the present invention.

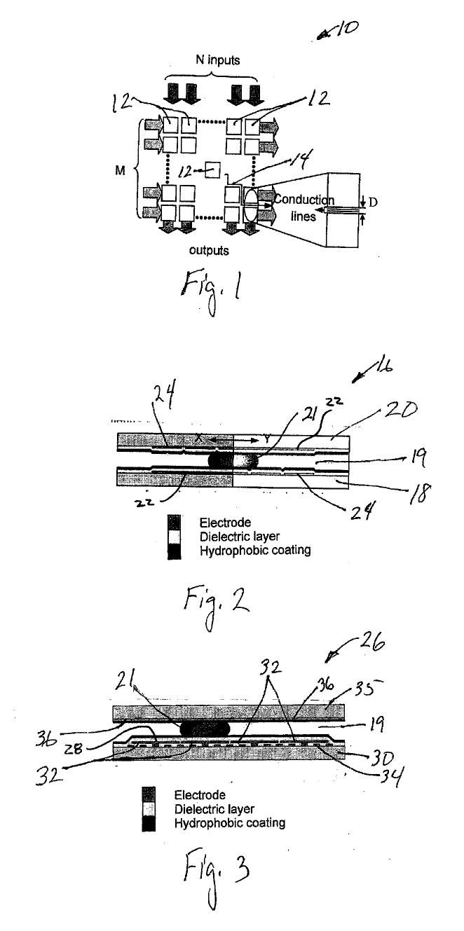

### DETAILED DESCRIPTION OF THE PREFERRED EMBODIMENTS

Referring to FIG. 4, the digital microfluidic system 50 of the present invention for performing various microfluidic functions on a droplet 52. The digital microfluidic device 50 comprises a PCB 56 having a substrate 58 which is typically formed of the material flame resistant 4 (“FR4”). The PCB was first developed to provide electrical interconnections to numerous isolated electrical components. To meet the requirements for denser and faster electrical connections by modern IC chips, the multi-layer PCB (as many as 30 layers) has been developed with smaller feature sizes. PCB had also been adapted to microfluidic systems as a substrate for making micro channels, micro pumps and sensor devices. A multi-layer PCB is generally fabricated by lapping several epoxy woven layers (usually FR4) with patterned copper (“Cu”) layers. The patterns in the copper layers are generally formed using well-known etching processes. To connect the different layers, vias are drilled through them and the via walls are also Cu electroplated. A typical 4-layer PCB constructed in this manner costs around $0.10/in², which is hundreds of times less than general IC processes. It should be noted that some PCBs are made of flexible materials including, for example, polymer films described by various different commercial names.

Still referring to FIG. 4, the first substrate layer 58 has a top surface 60 and a bottom surface (not shown in FIG. 4). A conductive layer 64 is disposed on the top surface 60. The conductive layer 64 on a typical PCB is made of a thin layer, typically 10 μm to 60 μm, of copper. The conductive layer 64 is formed into a pattern of individual electrode pads 66. The electrode pads 66 can be formed by well-known etching processes, by applying surface mounted solder pads also using known techniques, or other suitable methods of forming an array of electrode surfaces. Each of the electrode pads 66 has a perimeter, in this example a rectangular perimeter, as best shown in the top view of FIG. 5. It should be understood that the electrode pads 66 can be suitable shapes other than rectangular, including circular, elliptical, triangular, or other polygonal shape, although rectangular is preferred for reconfigurable digital microfluidic functions. There is a substantially non-conductive gap between the perimeters of each adjacent electrode pad 66 as electrical isolation.

It is possible that the copper conductive layer on a PCB substrate is not optimum for digital microfluidic operations. For example, the copper conductive layer may be thicker than desired, such that voltage required for operation is higher than desired, or the surface topology of the copper is too rough for efficient movement of droplets especially by electric fields. Thus, in other aspect of the present invention, a surface treatment is performed on the PCB substrate before completing the steps to form it into the microfluidic system 50. First, the copper conductive layer is removed from the substrate of the PCB. This may be accomplished by a wet etching or other suitable method. Then, a one or more very thin layer(s) of conductive material is deposited onto the substrate to form a new conductive layer 64. Alternatively, the thick conductive layer may be thinned down and smoothened by an appropriate method such as chemical and mechanical planarization (CMP) instead of stripping the thick conductive layer altogether and depositing a new layer. The array of electrode pads 66 is then formed in the conductive layer, such as by etching. At this point, the process is the same as described above with respect to the dielectric layer 70 and the hydrophobic layer 74.

A via 72 extends from each electrode pad 66 through the substrate 56 to the bottom surface of the substrate 56. Each via 72 provides electrical connections between its respective electrode pad 66 and the contact electrode at the bottom surface of the PCB 56 so that each electrode can be directly and independently electrically actuated through the via 72. Alternatively, a via 72 extends from each electrode pad 66 through the substrate 56 to another location on the top surface of the substrate 56. In this case, the middle Cu layers are essential. Each via 72 provides electrical connections between its respective electrode pad 66, the patterned middle Cu layers and the contact electrodes on the top surface of the PCB 56.

In order to provide electric isolation between the electrode pads 66 and the droplets 52, a dielectric layer 70 is provided on the conductive layer 64 (which is comprised of the electrode pads 66). The dielectric layer 70 may cover the top opening of the vias 72 to seal the vias from being exposed to liquid which could cause electrolysis of liquid during electric operations. The dielectric layer 70 may be made of any suitable dielectric material such as Parylene C, silicon dioxide, or silicon nitride. However, since the glass transition temperature of FR4 is 185° C., a PCB substrate formed of FR4 cannot be exposed to high temperature processes such as most silicon dioxide deposition which is performed at temperatures over 200° Celsius (“° C.”). In addition, lower temperature deposition methods tend to exhibit too many pin holes and poor dielectric properties. Therefore, Parylene C is a better choice as the dielectric material for its conformal, room temperature deposition characteristics. The dielectric constant of Parylene C is around 3.2, lower than that of silicone dioxide (4.5), but it is still effective for electric actuation such as EWOD. Moreover, as described above, Parylene C can also cover the step over the connection vias due to its conformal deposition. If the material of the dielectric layer 70 exhibits suitable hydrophobic properties for EWOD, then the dielectric layer 70 itself may be utilized as the driving surface of the digital microfluidic system 50. In other words, when an electric voltage or potential is applied to one or more of the electrodes 66, the surface wettability of the dielectric layer 70 will become less hydrophobic (or will change from hydrophobic to hydrophilic, or will become more hydrophilic, as the case may be). As a result, a droplet 52, or portions thereof, in the vicinity of the actuated electrodes 66 will tend to be pulled toward the actuated electrodes 66. Parylene C is hydrophobic and can be utilized as the driving surface.

If the dielectric layer 70 is not suitable for efficient electric operations, or just in the case that a better driving surface is desired, a hydrophobic layer 74 may be disposed on the dielectric layer 70 in order to improve the operational characteristics of the surface. Suitable materials for the dielectric layer 70 include Teflon, Cytop and other hydrophobic materials. The hydrophobic layer 74 can be applied onto the dielectric surface by any suitable method, such as spin coating, or other deposition methods as known in the art. The key function of the hydrophobic layer 74 is a low friction against droplet movements on the driving surface. As such, other low-friction materials can substitute the hydrophobic material.

The system 50 may be used with an open driving surface 74. In this case, the droplets 52 are in contact with only one plate and appear as a truncated sphere. Alternatively, a top plate 80 may be provided such that the droplets are confined between, and in contact with, two plates.

The top plate 80 is placed over the PCB 56 with spacers 82 inserted between the PCB 56 and the top plate 80 to create a droplet passage 84 between the driving surface 74 and the top plate 80. The top plate 80 may comprise a glass plate 86 having an inside surface which opposes the driving surface 74. The inside surface of the glass plate 86 may be coated with an electrically conductive layer 88, such as indium tin oxide (“ITO”). The electrically conductive layer 88 is used as a grounding electrode for the droplets 52. A second hydrophobic layer 89 is disposed onto the electrically conductive layer 88.

Thus, each of the electrode pads 66 can be directly and independently actuated by an electric potential applied through the via 72 to each electrode pad 66. In response to an electrical potential, the surface wettability of the driving surface 74 in the vicinity of the actuated electrodes is modified. By properly actuating the electrode pads 66, multiple droplets can simultaneously be manipulated by the system 50 as required for the process being performed by the system 50. For example, droplets may be created from a reservoir, moved, divided, and/or mixed, as desired.

### EXAMPLE

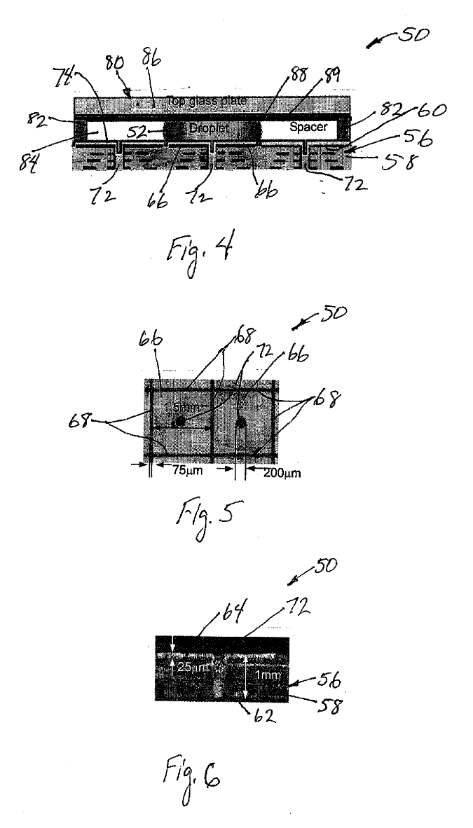

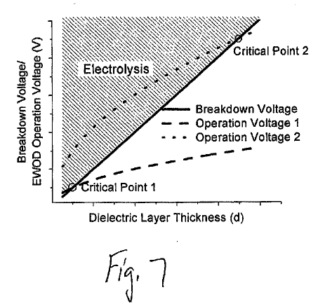

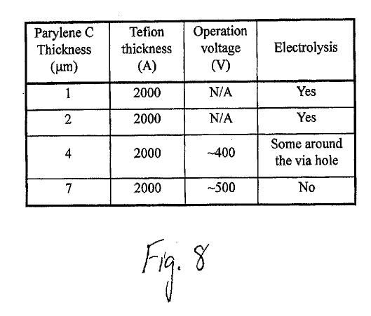

Referring to FIGS. 4-6, a specific example of a digital microfluidic system 50 according to the present invention will be described. The system 50 is physically configured as schematically shown in FIG. 4 and as described above. The PCB 56 has substrate 58 formed of FR4 and having an overall thickness of about 1 mm. The top conductive layer 64 is 25 μm thick copper. The array of electrode pads 66 formed by etching into an 8×8 rectangular array. Each electrode pad 66 has a square shape which is 1.5 mm wide. The gap 68 between the perimeter of each electrode 66 and the perimeter of each adjacent electrode is 75 μm. The vias 72 have a diameter of 200 μm.

The dielectric layer 70 is formed of a 5000 Angstrom (“Å”) thick layer of Parylene C applied by conformal, room temperature deposition. Over the dielectric layer, the hydrophobic layer 74 is a 2000 Å thick layer of FC75 AF1600 Teflon which is spin coated on top to make the surface more hydrophobic (resulting in a contact angle ˜120°). The top cover 80 is formed of a glass plate 86 coated with 1400 Å ITO and a 2000 Å thick coating of Teflon.

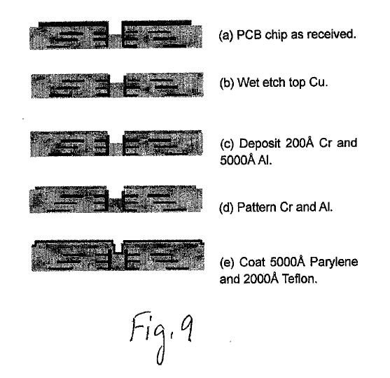

A major failure mechanism of EWOD actuation is electrolysis by electric leakage through the dielectric layer. FIG. 7 shows that the voltage required to induce a specific contact angle change is proportional to the square root of the dielectric layer thickness while the breakdown voltage is linearly proportional to the dielectric thickness. Below a certain thickness, dielectric breakdown occurs before actuation is achieved by EWOD force. For larger contact angle changes (i.e., larger drive force), the minimum dielectric thickness is larger. Since PCB substrates exhibit amplified topography and rougher surfaces and offer more resistance against droplet movement than glass or silicon substrate, higher operation voltages and thicker dielectric layers are required.

Accordingly, the performance of this microfluidic system 50 was evaluated by conducting a series of tests on the system 50 under varying operation voltages and dielectric layer 70 thicknesses.

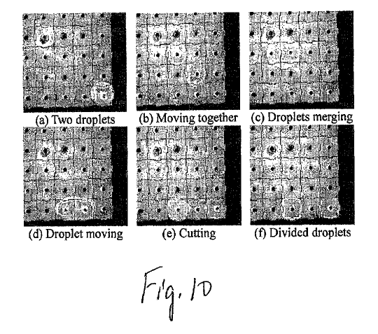

Accordingly, to test the EWOD performance of the digital microfluidic system 50, a series of tests were conducted using varying operation voltages and dielectric layer 70 thickness. The results of these tests are shown in the table of FIG. 8. With reference to FIG. 8, the tests reveal that at least 7 μm of Parylene C and 500V of driving voltage are needed for successful droplet actuation. This operation voltage is 10 times larger than is typical on silicon or glass substrate. High operation voltages can cause possible electrical shorts on a PCB and require a high voltage source, a special control circuit and extra safety protection for microfluidic systems. Although the system 50 as configured operated and is useful, it was desirable to decrease the operation voltage for the microfluidic system 50.

Several observations were made during the testing which led to improvements in the EWOD performance of the digital microfluidic system 50. For one, when we initially put a droplet between two adjacent electrodes, with 70-80V on a 1 μm Parylene C chip, the droplet could be moved back and forth between those two electrodes but failed to move any further. After careful examination, it was suspected that the trench between the two electrodes prevented the droplet from further movement. In comparison to the PCB substrate, a similar electrode configuration on a glass or silicon substrate, with electrode thickness of 2000-3000 Å and an electrode gap of 4-10 μm, allowed the droplet to spread to the adjacent electrode by itself and helped the initial EWOD actuation. However, on the PCB substrate, the droplet could not move across the trench to contact the next electrode. Ultimately, the initial EWOD driving force was smaller and a larger operation voltage was required to begin the droplet continuing movement. Therefore, it was concluded that the surface topography and the gap between electrodes on the PCB based microfluidic system 50 must be reduced to decrease the operation voltage.

In order to reduce the gap between the electrodes and to reduce the surface topography, the thickness of the top conductive layer 74 must be reduced. Although a thinner copper conductive layer 74 and smaller feature sizes are also desired for PCB manufacturing, current technology only allows a copper thickness as thin as about 10 μm and feature sizes of about 100 μm. As such, traditional PCB technology can not satisfy our requirements. Therefore, additional PCB processing methods have been developed to reduce the surface topography of the PCB substrate.

It should be noted, at this point, that the above testing was done in air environment. If the liquid droplet is surrounded by another immiscible liquid (e.g., water droplets in oil) instead of air, the droplets start to move much easier, resulting in lower driving voltage. In this case, the thinning down of the electrode pads may not be necessary.

The complete PCB processing method is shown in FIG. 9: (a) receive PCB chip from manufacture; (b) remove the 25 μm copper conductive layer while protecting the copper around the vias (if the board comes with vias); (c) apply a replacement conductive layer onto the substrate, such as by evaporating 200Å chromium (“Cr”) layer and 5000 Å aluminum (“Al”) layer; (d) create an array of electrode pads in the Cr/Al layer with about a 4-10 μm gap between electrode pads by etching or other suitable process; and (e) apply a coating of 5000 Å Parylene C and a coating of 2000 Å Teflon. If the vias are not provided in the PCB chip as received, the vias may be provided before after etching the conductive layer.

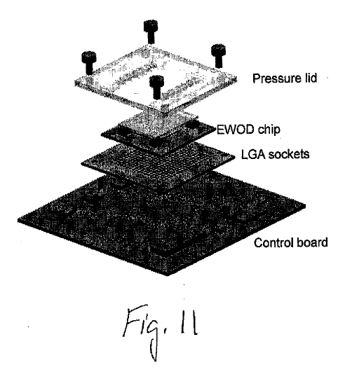

Performance of the digital microfluidic system 50 when using this PCB processing method was verified by testing essential digital microfluidic operations (i.e., moving, mixing and cutting) on an 8×8 PCB EWOD chip with 70Vp-p, 1 kHz AC voltage as shown in FIG. 10. In order to facilitate droplet cutting/splitting, 200 μm high spacers were placed between electrodes to define the channel height. As shown in FIG. 10, the two droplets move from their positions in view (a) toward each other as shown in view (b). Then, in view (c), the droplets are merged together. The larger, merged droplet is moved to the position as shown in image (d). In view (e), the merged droplet is being cut, and is shown fully divided in view (f).

With this PCB processing method, the EWOD operation voltage was decreased to 50-70V, which is in the same range as that of a glass or silicon substrate. The PCB processing cost is comparable to the PCB cost, and the overall scheme is still similarly economical as compared to IC chips. With no additional parts required other than the digital microfluidic chip and supporting electronics and with low power consumption to operate, the entire system 50 may be made handheld in size and portable (i.e., battery powered).

In another aspect of the present invention, the digital microfluidic system 50 may be packaged in various ways for convenient use. For example, the digital microfluidic system 50 may occupy only a portion of the PCB board on which it is implemented, with the rest of the board including supporting electronics and other functions as well. In this case, the entire system may be implemented on one PCB. Alternatively, the PCB microfluidic system 50 can be mounted on a separate control system permanently (e.g. soldered) or removably (e.g. inserted into plug-in).

In still another alternative, the microfluidic system can be configured to interface with a convenient packaging scheme utilizing a high density grid array. Electrical connection and control requirements for a direct referencing device increase rapidly with increased grid number and can quickly overwhelm the system design. There exist many high density (0.7 mm pitch), high connection number (thousands of pins) packages for IC chips: such as ball grid array (BGA), pin grid array (PGA), land grid array (LGA) etc. For the LGA package, instead of using pins or balls, Cu pads are made on the substrate to contact with the LGA socket and then connected to the control board. Because the digital microfluidic system 50 uses a PCB as the fluidic chip substrate, the Cu pads array can be readily made on the bottom side of the PCB substrate 58 . As shown in FIG. 11, the whole packaging scheme can be based on the LGA socket. The LGA socket 90, oriented to correspond to the Cu pad array, is inserted for electrical connection between the microfluidic device 50 and a control circuit board 92. A top pressure lid 94 covers and fixes the microfluidic system 50, with screws 96 producing the required contact force between the Cu pads on the bottom of the microfluidic device and the LGA sockets. This package scheme greatly simplifies the system development and enables a scalable digital microfluidic system 98.

Thus, a directly referencing digital microfluidic system based on EWOD principles is provided using a PCB substrate. With simple PCB processing methods, essential droplet functions can be fulfilled on a PCB EWOD chip below 100V AC signal, similar to silicon and glass substrates. With the low cost fabrication of the PCB substrate and comparable costs for the PCB processing, the PCB EWOD chip can be disposable. The PCB substrate is also shown to be compatible with the LGA socket package scheme, which greatly simplifies the system development and enables a scalable microfluidics.

While the preferred embodiment describes an EWOD-based motive force for moving droplets and/or bubbles, it should be understood that the PCB-based structure may also be used to take advantage of electrophoretic or electrostatic forces to move small objects. For example, the electrostatic force may be used to selectively move one or more solid or particulate objects over a surface containing a plurality of addressable electrode pads of the type disclosed herein.

While embodiments of the present invention have been shown and described, various modifications may be made without departing from the scope of the present invention. The invention, therefore, should not be limited, except to the following claims, and their equivalents.

What is claimed is:

1. A device for moving small objects comprising:
a substrate comprising a printed circuit board, the printed circuit board having a plurality of electrically isolated electrode pads disposed on an upper surface, the plurality of electrode pads operatively coupled to a plurality of electrical connections passing through the substrate, wherein each electrode pad is configured to be electrically activated independently of the other electrode pads;
a driving surface disposed over the plurality of electrode pads, the driving surface comprising a surface on which small objects may be placed and manipulated by the device; and
wherein each electrode pad is capable of moving one or more small moveable objects disposed on or above the driving surface in response to an electrical potential applied to at least one of the electrode pads.

2. The device of claim 1, wherein the small moveable object is selected from the group consisting of solid particles, liquid drops, gas bubbles, and their combinations, and the small moveable objects are immersed in a gas or a liquid.

3. The device of claim 1, further comprising a top plate placed over the printed circuit board with a space formed between the top plate and the printed circuit board such that the space forms a passage for the movable objects, a surface of the passage comprising the driving surface.

4. The device of claim 1, wherein the driving surface is selected from the group consisting of a dielectric layer disposed on the electrode pads, a low-friction layer disposed on the electrode pads, and a low friction layer overlaying a dielectric layer, the dielectric layer disposed on the electrode pads.

5. The device of claim 1, wherein the electrical connections comprise a plurality of vias extending from the electrode pads into the substrate to other surface locations of the substrate through intermediate conductive layers present in the substrate.

6. The device of claim 1, wherein a plurality of vias extends from the electrode pads through the substrate to a bottom surface of the substrate.

7. The device of claim 1, wherein the substrate layer is formed of one of FR4 or other materials used for printed circuit boards, and the electrode pads are formed of a copper layer or other materials used for printed circuit boards.

8. The device of claim 1, wherein the plurality of electrode pads is arranged in a predetermined pattern and the gap between the perimeters of adjacent electrode pads is between one (1) micrometer to one (1) millimeter.

9. The device of claim 4, wherein the electrode pads are formed of a conductive layer having a thickness of less than 100 micrometers, the dielectric layer has a thickness of less than 10 micrometers, and the low-friction layer has a thickness of less than 10 micrometers.

10. The device of claim 1, wherein the voltage required to move a small object on the driving surface is less than about 300 volts.

11. The device of claim 1, further comprising an interface device having a plurality of electrical connections electrically coupled to the contact electrodes, and a control board operatively coupled to the interface device, the control board configured to selectively apply voltages individually to each of the electrode pads to manipulate the small objects on the driving surface.

12. The device of claim 11, wherein the interface device is selected from the group consisting of insert-type connections, a ball grid array, pin grid array and a land grid array.

13. A method of producing an object moving system, comprising the following steps:
(a) providing a substrate comprising a printed circuit board;
(b) forming a plurality of electrically isolated electrode pads disposed on an upper surface of the printed circuit board;
(c) providing an electrical connection for each electrode pad, each electrical connection operatively coupled to its respective electrode pad and extending from the electrode pad into the substrate and electrically connecting to contact electrodes at other surface locations; and
(d) wherein the plurality of electrodes are capable of imparting a force on the movable objects in response to an electrical potential applied to at least one of the electrodes.

14. The method of claim 13, further comprising the step of providing a driving surface over the plurality of electrode pads, wherein the driving surface is selected from the group consisting of the electrode pads, a dielectric layer disposed on the electrode pads, a low-friction layer disposed on the electrode pads, and a low-friction layer overlaying a dielectric layer, the dielectric layer disposed on the electrode pads.

15. The method of claim 13, wherein, prior to step (b), a conductive layer on a top surface of the substrate is removed and a replacement conductive layer is provided on a top surface of the substrate, wherein the replacement conductive layer has a thinner and smoother surface topography than the removed conductive layer.

16. The method of claim 13, wherein, prior to step (b), a conductive layer on a top surface of the substrate is thinned down and/or smoothed by a lapping or polishing process.

17. The method of claim 14, further comprising the step of providing a top plate over the driving surface so as to form a passageway for the moveable objects.

18. The method of claim 13, wherein the printed circuit device is coupled with an interface device selected from the group consisting of insert-type connections, a ball grid array, pin grid array and a land grid array.

19. The method of claim 13, wherein the force is one of an electrowetting force, an electrophoretic force, a dielectrophoretic force, and an electrostatic force.

20. The method of claim 14, wherein the low-friction layer comprises a hydrophobic polymer.
